(19) United States
(12) Patent Application Publication
(10) Pub. No.: US 2026/0221359 A1
(43) Pub. Date: Jul. 30, 2026

(54) WELDING ARC-ENDURING COMPONENT TO STRUCTURAL OR MECHANICAL COMPONENT FOR ASSEMBLY OF VACUUM INTERRUPTER

(71) Applicant: Wangpei Li, Pittsburgh, PA (US)

(72) Inventor: Wangpei Li, Pittsburgh, PA (US)

(21) Appl. No.: 19/037,078

(22) Filed: Jan. 25, 2025

(51) Int. Cl. H01H 33/662

(52) U.S. Cl. CPC H01H 33/66261; H01H 2033/66269; H01H 2033/66276

(57) ABSTRACT

Vacuum switching apparatus such as a vacuum interrupter includes arc-enduring components, in the role of the arc-shield or the contacts, of an arc-enduring material such as Cu—Cr or Cu—Fe, joined to other structural or mechanical support components, in the role of the end-curls or the contact support, of an economic but strong material such as steel or iron. By employing welding instead of brazing to join these two dissimilar materials, it becomes possible to electrically join fraction, instead of the entirety, of the mutual faying surfaces of the two components. This separation between mechanical and electrical connections allows the mechanical support component to provide maximal and optimal mechanical support while minimizing its negative impact on electrical functioning of the joined assembly. Additionally, it enables the arc-enduring component to be made in a simpler or thinner geometry, improving the likelihood for it to be formed net-shape or near-net-shape.

### BACKGROUND

### 1. Field

The disclosed concept relates to vacuum switching apparatus and in particular vacuum switching apparatus such as, for example, a vacuum interrupter (VI). The disclosed concept also relates to shield assemblies, contact pre-assemblies, contact-coil assemblies, and associated assembly methods for vacuum interrupters (VIs).

### 2. Background Information

The following is a tabulation of some prior art that presently appears relevant:

U.S. Patents

| Patent Number | Kind Code | Issue Date | Patentee |
|---|---|---|---|
| 10,134,546 | B2 | 2018 Nov. 20 | Li |
| 10,490,363 | B2 | 2019 Nov. 26 | Li et al. |
| 8,779,317 | B2 | 2014 Jul. 15 | Kim |
| 10,153,111 | B2 | 2018 Dec. 11 | Yu et al. |
| 11,721,503 | B2 | 2023 Aug. 8 | Kawada |
| 8,450,630 | B2 | 2013 May 28 | Stoving |
| 10,418,211 | B2 | 2019 Sep. 17 | Baron et al. |
| 10,796,867 | B1 | 2020 Oct. 6 | Li et al. |

Japanese Patent

| Patent Number | Kind Code | Issue Date | Patentee |
|---|---|---|---|
| JP 5,281,192 | B2 | 2013 May 31 | Itotani |

### Nonpatent Literature Document

Kowanda, C., Hochstrasser M., Schwaiger A., and Muller F. E. H., “Net Shape Manufacturing of CuCr for Vacuum Interrupters”, IEEE Transactions on Dielectrics and Electrical Insulation, 18 (6), p 2131-2137 December 2011.

VIs generally include a vacuum envelope that provides the vacuum environment for the proper functioning of vacuum switching. The envelope typically includes an insulator cylinder caped on both ends with metal end-caps. There is in general at least one shield that protects the internal, on the vacuum side, surface of the insulator. The shield can be a monolithic single piece made of Cu or steel. It can also be, in a more advanced construction for applications needing high current interruption, an assembly of more than one component, with one of them, often referred to in the field as the arc-shield, being a thick-wall cylinder of a Cu—Cr or Cu—Fe alloy that can better withstand electric arcing, and the other components made of a thin-wall steel that is both cost effective and excellent in vacuum dielectric, to supplement the arc-shield to achieve the optimum structural shape and hence shielding functions. Because the VI manufacturing process necessarily involves brazing such as vacuum brazing or hydrogen brazing (to join the ceramic insulator with the metal end-caps, for one purpose), historically the Cu—Cr or Cu—Fe arc-shield component and the steel components are joined together in the same or a separate brazing step. That is, their joints are brazed joints. Brazing entails the use of a filler part, which in turn necessitates a certain step or groove or void machined onto the Cu—Cr or Cu—Fe arc-shield, to secure the filler part in position during furnace brazing. This step or groove or void weakens both the mechanical strength of the arc-shield, and its ability to withstand extended electric arcing duties. To accomplish optimum combination of both mechanical and electrical performances of the shield assembly, an elaborated geometry often has to be machined onto this Cu—Cr or Cu—Fe arc-shield, for example, as prescribed in U.S. Pat. No. 10,134,546. This Cu—Cr or Cu—Fe arc-shield often has to be machined dry, i.e. without lubrication, making its machining an expensive operation. It is desirable, therefore, to have this Cu—Cr or Cu—Fe arc-shield formed net-shape, i.e. without the need for subsequent machining. But the step or groove or void required by brazing makes net-shaping difficult.

VIs generally also include a pair of separable arcing contacts inside the vacuum envelope. For VIs used in circuit breaker applications, the contacts usually are made of a Cu—Cr material, and in rare cases a Cu—Fe material. This pair of Cu—Cr or Cu—Fe contacts together perform the electrical functions of high fault current breaking during opening and voltage withstand when they are in the open state. They also have to maintain their integrity under very demanding mechanical loading conditions during the fault making and weld-breaking processes, as well as during the cyclic mechanical life endurance test. To meet these mechanical strength requirements, the contacts have to be made thick enough, necessitating a high cost for this expensive component of a VI. For the most demanding applications such as in a generator circuit breaker, additional means have to be developed to improve the mechanical performance of the contacts themselves, such as prescribed in U.S. Pat. No. 10,490,363, where costly dry milling steps on the Cu—Cr contacts are added. Alternatively, there are means to support the contacts with a steel reinforcement piece, such as described in U.S. Pat. Nos. 8,779,317, 10,153,111, and 11,721,503. This mechanical support piece, if not physically joined to the contact, only helps the performance of the VI against a compressive load, but not against a tensile load such as when the VI has to break a weld between the pair of contacts. If this mechanical support piece is physically and hence electrically joined to the contact through a brazing process, it will divert a significant fraction of current flow through it to the contact. This compromises the current flow control necessary for current interruption performance. Hence tradeoff becomes necessary when designing a VI, to balance between a beefy piece for good mechanical support, and a thin or elaborated piece with small cross section area to minimize the amount of current flow through it, for example, as described in Jap. Pat. No. 5,281,192 and U.S. Pat. No. 8,450,630. This balancing act becomes very difficult, and yet critical, in the new technological frontier of developing a VI for high voltage (HV) applications, because the contact, the coil and the electrodes are all very large and heavy and the opening speed is very high. Multiple mechanical support components may have to be employed to ensure structural and mechanical integrity of the entire contact-coil assembly, such as prescribed in U.S. Pat. Nos. 10,418,211 and 10,796,867.

There is, therefore, room for improvement in vacuum switching apparatus, such as VIs, and in joining their Cu—Cr or Cu—Fe components such as the arc-shield and the contacts, with other components, in the design and manufacturing of the vacuum switching apparatus.

### SUMMARY

These needs and others are met by embodiments of the disclosed concept, which are directed to the shield assembly, the contact pre-assembly, the contact-coil assembly, and associated assembly methods for vacuum switching apparatus, such as VIs. By replacing the brazed joints between the arc-enduring components and the other structural or mechanical components, or some or part of the joints, with welded joints, i.e. formed via welding, the arc-enduring components can be made stronger and cheaper, for example using a net-shape or near-net-shape forming process. Unlike brazing, which is difficult to achieve partial joining between 2 mutual faying surfaces, the welding techniques nowadays are well capable of joining, hence electrically connecting, only portion of the mutual faying surfaces, thereby solving the problem of contradiction between mechanical function and electrical function of the joined assemblies.

As one aspect of the disclosed concept, a shield assembly is provided for a vacuum switching apparatus such as a VI. The shield assembly includes an arc-enduring arc-shield made of a material containing at least 40% by weight of copper, such as Cu—Cr (herein defined as containing at least the elements of Cu and Cr) or Cu—Fe (herein defined as containing at least the elements of Cu and Fe), and at least one other structural component made with a non-copper material (herein defined as containing no more than 10% by weight of copper) such as a common steel or iron. The joint, or portion of it, between the arc-shield and the other component is welded, instead of brazed. In this way the Cu—Cr or Cu—Fe arc-shield is more adapted to being made economically in a simple geometry, and possibly through a net-shape forming process. Additionally, because there is no more need to manually assemble the braze filler part into a groove or step, then to braze the assembly through an expensive and time-consuming furnace heating and cooling cycle, the shield assembly making process is more adapted to automation, enabling lower manufacturing cost and shorter lead time. Furthermore, without the need for the step or steps on the cylindrical wall of the arc-shield, it can have a thinner wall with a uniform thickness, for given performance. This in turn may allow for a larger diameter of the contact pair to be built into the VI, to achieve an improved interruption performance.

As another aspect of the disclosed concept, a contact pre-assembly is provided for a vacuum switching apparatus such as a VI. The contact pre-assembly includes an arc-enduring contact containing at least 40% by weight of copper, such as a Cu—Cr alloy or a Cu—Fe alloy, of the so-called transverse magnetic field (TMF) or alternatively the radial magnetic field (RMF) type, and at least one mechanical support component, made of a non-copper material such as steel or iron, to reinforce the contact. The joint, or portion of it, between the Cu—Cr or Cu—Fe contact and the mechanical support component is welded, instead of brazed. In this way the Cu—Cr or Cu—Fe contact is more adapted to being made thinner, possibly even via a net-shape or near-net-shape forming process (defined herein as having at least the slots formed), such as described in the published paper by Kowanda et al. (“Net Shape Manufacturing of CuCr for Vacuum Interrupters,” IEEE Transactions on Dielectrics and Electrical Insulation, 18 (6), p 2131-2137 December 2011.) Unlike brazing, the capability of the welding process to only join certain preferred locations of the faying surfaces of the contact and the mechanical support piece, allows a VI with such a contact pre-assembly to achieve strong mechanical performance under all loading conditions including compressive or tensile or cyclic loading, without concern for the electrical functioning of the VI being compromised. Additionally, such a contact pre-assembly (formed by this method of pre-assembling and partial welding) enables the mechanical support piece to also serve the purpose of the contact shield, thereby eliminating the need of the latter (the contact shield) and reducing the cost of the VI.

As yet another aspect of the disclosed concept, a contact-coil assembly is provided for a vacuum switching apparatus such as a VI of the so-called axial magnetic field (AMF) type. The contact-coil assembly includes a copper coil that channels the electric current flow to generate the AMF, and a contact pre-assembly comprising a Cu—Cr or Cu—Fe contact, and at least one steel or iron reinforcement component to support the contact and the coil. In the known prior art, the joints between the contact and the coil, and the joint between the contact and the mechanical support piece, are brazed in the same furnace brazing run. The multiple faying surfaces of the coil to be brazed to the bottom (i.e. the non-arcing) side of the contact, and the faying surface of the mechanical support piece to be brazed to the same contact bottom side, have to be assembled perfectly coplanar (or parallel if offsetted), to achieve good brazing quality of all of these joints. This is not easy and a high scrap rate in production often occurs. By pre-welding the mechanical support piece to the contact then brazing the welded pre-assembly to the coil, this problem is avoided. And just like in the TMF contact pre-assembly case described in the above paragraph, by welding instead of brazing the mechanical support piece to the contact, the Cu—Cr or Cu—Fe contact is more adapted to being made thinner, possibly even via a net-shape or near-net-shape forming process, for cost-saving. And similarly, the capability of the welding process to only join certain preferred locations instead of the entire mutual faying surfaces of the contact and the mechanical support piece, allows flexibility for the design of the latter, to better enable the contact-coil assembly to achieve strong performance both mechanically and electrically. This is of particular importance in the new technological frontier of developing a VI for high voltage (HV) applications, where the heavy moving mass combined with the high operation speed demands adequate mechanical integrity in tandem with the extremely challenging electrical requirements. Another benefit in this aspect of high voltage advancement is that, with the mechanical support piece already welded on the contact, it is much easier (and operationally safer) to chuck on the mechanical support piece (than to grip on the thin contact itself) to machine a smooth round along the edges of the slots on the contact arcing surface, for improved dielectric performance of the contact.

As a further aspect of the disclosed concept, a method of shield assembly comprises: providing an arc-shield containing at least 40 percent by weight of copper, such as a Cu—Cr or a Cu—Fe alloy, and a second component made of a non-copper material such as steel or iron, and welding at least part of the joint between the Cu—Cr or Cu—Fe arc-shield and the second component.

As a further aspect of the disclosed concept, a method of forming a contact pre-assembly for a vacuum interrupter comprises: providing a contact containing at least 40 percent by weight of copper, such as a Cu—Cr or a Cu—Fe alloy, and a mechanical support component made of a non-copper material such as common steel or iron, and welding at least part of the joint between the Cu—Cr or Cu—Fe contact and the mechanical support component to form a contact pre-assembly. This contact pre-assembly can then be further assembled with other components to form the VI.

As yet a further aspect of the disclosed concept, a method of making a contact-coil assembly comprises: providing a coil that directs the current flow to generate an AMF, a contact containing at least 40 percent by weight of copper, such as a Cu—Cr or a Cu—Fe alloy, and a mechanical support component made of a non-copper material such as common steel or iron, welding at least part of the joint between the Cu—Cr or Cu—Fe contact and the mechanical support component to form a contact pre-assembly, and assembling this contact pre-assembly with the coil to form a contact-coil assembly. This contact-coil assembly can be assembled with other components to form the VI.

The welding step to weld the arc-enduring component of the arc-shield or the contact with the structural or mechanical component of the non-copper material comprises employing welding means such as laser beam welding or electron beam welding or plasma welding.

The welding step to weld the arc-enduring component of the arc-shield or the contact with the structural or mechanical component of the non-copper material may further comprise employing means to minimize discoloration of the workpiece, for example providing a shielding gas such as argon or helium for the welding, or carrying out the welding in an evacuated chamber, or cooling the workpiece with a water-cooled fixture or heat sink, or applying anti-scale coatings or paste to the work piece.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of a TMF VI in accordance with the prior art, with an azimuthal quadrant of the generally tubular components of the ceramics, the shield assembly, the end-caps, the end-shields, the bellows and the bellows shield removed;

FIG. 1A is a partial sectional view of the VI in FIG. 1 for the portion containing the shield assembly and the contacts;

FIG. 2 is a sectional view of an AMF VI in accordance with the prior art;

FIG. 2A is an exploded view of the contact-coil assembly of the VI in FIG. 2;

FIG. 3 is an isometric view of a TMF VI in accordance with certain embodiments of the disclosed concept, with an azimuthal quadrant of the generally tubular components of the ceramics, the shield assembly, the end-caps, the end-shields, the bellows and the bellows shield removed;

FIG. 3A is a partial sectional view of the VI in FIG. 3 for the portion containing the shield assembly and the contact pre-assemblies;

FIG. 4 is a front perspective view of another contact pre-assembly in accordance with another non-limiting embodiment of the disclosed concept;

FIG. 5 is a sectional view of an AMF VI in accordance with certain embodiments of the disclosed concept;

FIG. 6A is a sectional view of another contact-coil assembly in accordance with another non-limiting embodiment of the disclosed concept;

FIG. 6B is an isometric view of the contact-coil assembly in FIG. 6A;

FIG. 6C is an exploded view of the contact-coil assembly in FIG. 6B;

FIG. 7A is a half front perspective view and half sectional view of welding a joint in a shield assembly;

FIG. 7B is a front perspective view of welding a joint in a contact pre-assembly;

FIG. 7C is a front perspective view of welding a joint in another contact pre-assembly;

FIG. 8A is an exploded view of assembling a movable end of a VI employing a contact pre-assembly;

FIG. 8B is an exploded view of assembling a fixed end of a VI employing a contact pre-assembly;

FIG. 9A is an exploded view of assembling a contact-coil assembly employing a contact pre-assembly; and

FIG. 9B is an exploded view of assembling a fixed end of a VI employing a contact pre-assembly and a contact-coil assembly.

All sectional views herein are taken across a diameter and along the central axis of the tubular VI.

### DESCRIPTION OF THE PREFERRED EMBODIMENTS

As employed herein, the singular forms “a,” “an,” and “the” include plural references unless the context clearly dictates otherwise. Unless defined otherwise, all technical and scientific terms used in this document have the same meanings as commonly understood by one of ordinary skill in the art. As employed in this document, the term “comprising” (or “comprises”) means “including (or includes), but not limited to.”

As employed herein, the term “vacuum envelope” means an envelope employing a partial vacuum therein. As employed herein, the term “partial vacuum” means a space (e.g. within a vacuum envelope) partially exhausted (e.g. to the highest degree practicable; to a relatively high degree; to a degree suitable for use in a vacuum switching apparatus application) by a suitable mechanism (e.g. without limitation, a vacuum furnace).

The disclosed concept is described in association with VIs, although the disclosed concept is applicable to a wide range of vacuum switching apparatus. Non-limiting applications for vacuum switching apparatus include a circuit breaker, a switch, a generator circuit breaker, a load break switch (LBS), a contactor, a low voltage (LV) switching apparatus, a medium voltage (MV) switching apparatus, a high voltage (HV) switching apparatus, and a vacuum electrical switching apparatus.

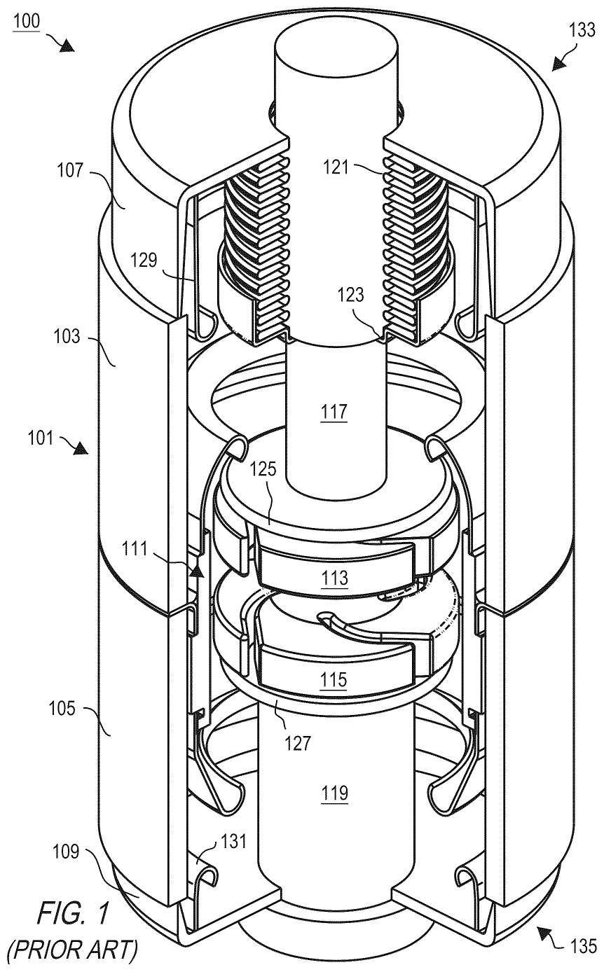

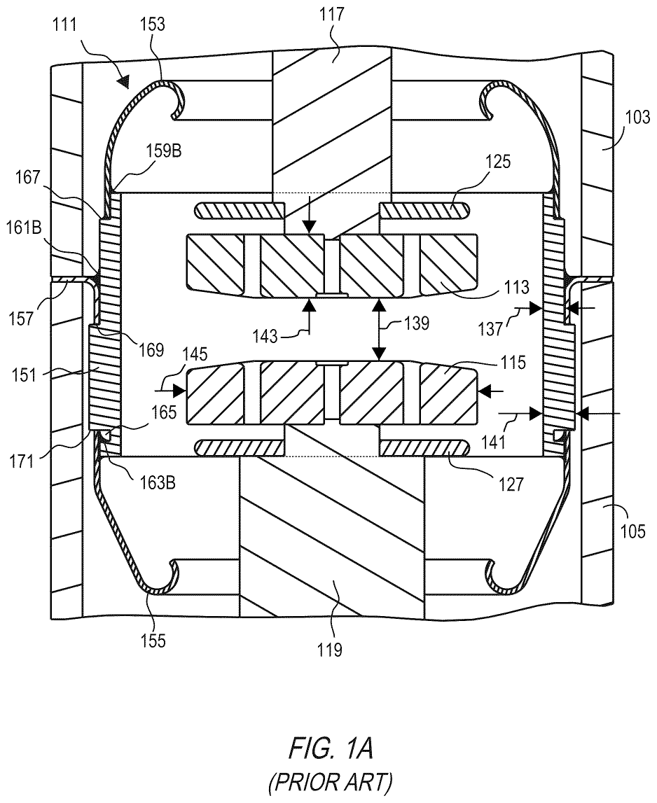

Referring to FIG. 1, a VI 100 of the TMF type in accordance with the prior art is shown. It includes a vacuum envelope 101 comprising two tubular ceramic insulator members 103 and 105 caped with two metal end-caps 107 and 109. Inside the vacuum envelope 101 is a shield assembly 111, which protects the internal walls of the insulator members 103 and 105 against deposit of metal vapor and splash generated by arcing activities between a pair of separable electrical contacts, the movable contact 113 and the fixed contact 115. Two electrodes 117 and 119 connect the contacts to electrical busbars (not shown) exterior to the vacuum envelope 101. A bellows 121 facilitates the driving of the movable contact 113 into or out of electrical contact with the fixed contact 115 by an external mechanism (not shown) without breaking the vacuum envelope. A bellows shield 123 protects the thin-walled bellows from any hot splash originating from arcing activities in between the opening contacts. Not always but often there are two contact shields 125 and 127, that further reduce the amount of splashing and metal vapor that can potentially reach the insulators and the bellows. Not always but often there are also two end-shields 129 and 131 that protect the triple junctions of the ceramic to metal joints. Commonly in the industry the metal parts are grouped into two ends, a movable end 133 and a fixed end 135, separated by the insulators 103 and 105. The movable end 133 (the upper end in FIG. 1) includes the metal parts of 113, 125, 117, 121, 123, 107, and 129. The fixed end 135 (the lower end in FIG. 1) includes the metal parts of 115, 127, 119, 109, and 131.

FIG. 1A shows the cross-sectional structure of the shield assembly 111, which comprises an arc-shield 151, two end-curls 153 and 155, and a flange 157. The arc-shield 151 surrounding the contacts 113 and 115 performs the heavy duty of withstanding the bombardment of hot metal splash and vapor originating from arcing activities in between the opening contacts, even occasional direct hitting of the arc itself. Commonly it is made of an arc-enduring alloy containing at least 40% by weight of copper, such as Cu—Cr or Cu—Fe. Attached to its two ends (along the axis of its generally tubular, circularly or non-circularly, shape) are the end-curls 153 and 155, which help further capture the metal vapor to prevent it from reaching the insulator surface, and also direct the flow of the equipotential lines in the dielectric design of the VI 100. They are often punch-formed from a thin sheet of a non-copper material such as stainless steel or carbon steel. In the known prior art, the Cu—Cr or Cu—Fe arc-shield 151 and the steel end-curls 153 and 155, and often but not always, the flange 157 are brazed together in one brazing furnace run. To facilitate the placement of the braze filler parts often in the shape of a ring or a washer (not shown—although the illustrative blacken parts 159B, 161B, 163B, not drawn to scale, intend to represent them in the molten then resolidified shape and state after brazing, in the thus formed braze joints), a groove 165, and steps 167, 169, 171, are machined onto the arc-shield. Machining of the Cu—Cr or Cu—Fe arc-shield is an expensive operation as it is carried out dry, i.e. without lubrication. Moreover, the groove and the steps weaken the mechanical strength of the arc-shield, and reduce its effective thickness (—dimension 137, defined as the minimum wall thickness in the portion for the axial location corresponding to the contact gap 139) that is usable to endure arcing (in despite of a large starting stock thickness 141).

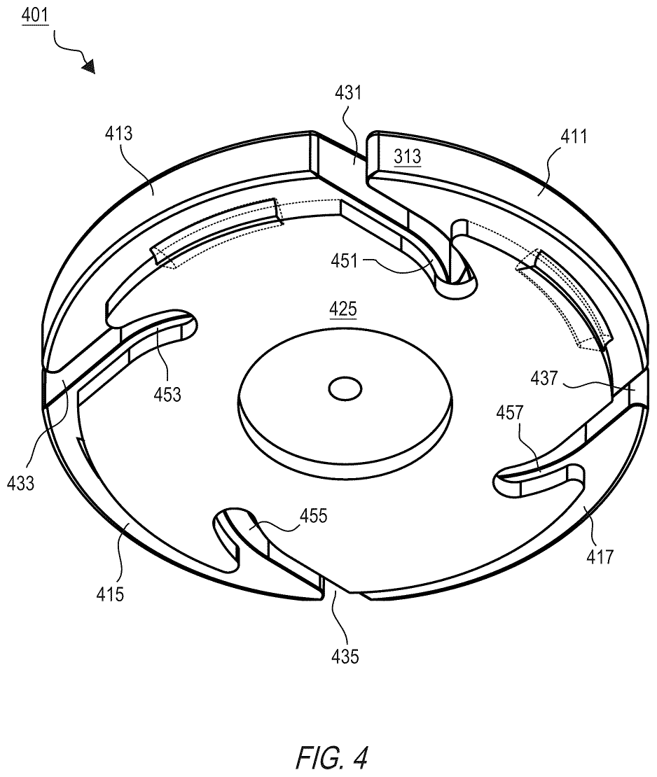

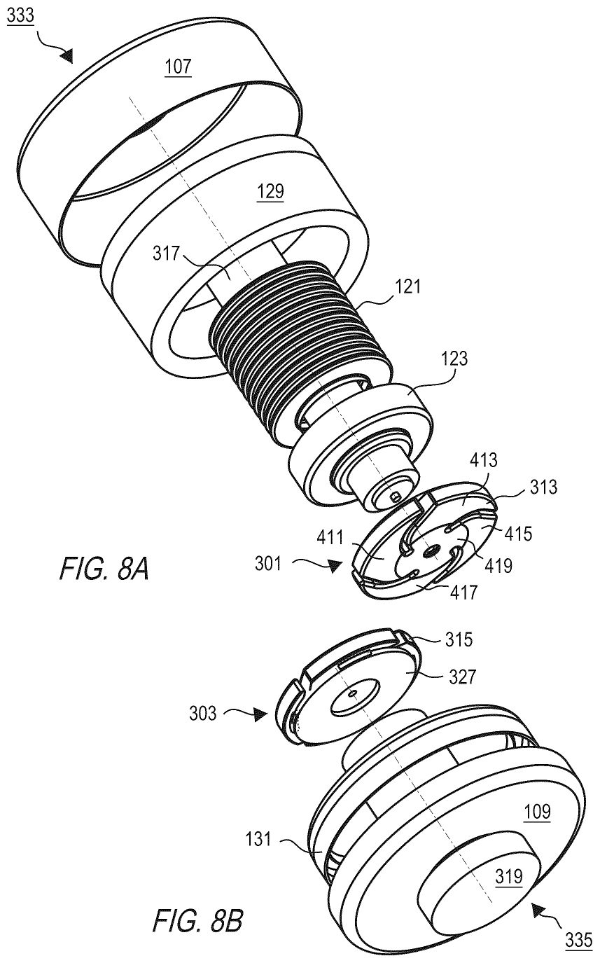

The exemplary contacts 113 and 115 shown in FIGS. 1 and 1A are of the spiral petal TMF type, with a plurality of spiral petals extending from the center hub outwardly diameter-wise (see 411, 413, 415, and 417 for the four petals and 419 for the hub in the contact 313, which is of an identical structure as 113 except only thinner and slightly larger in diameter, in FIGS. 4 and 8A). They are commonly made of an arc-enduring material containing at least 40% by weight of copper, for example a Cu—Cr alloy or a Cu—Fe alloy. To meet a comprehensive package of electrical and mechanical performance requirements the contact material does not have the strongest mechanical strength. (For example, a material with too high of strength is not good for weld-breaking performance, when a weld formed between the contact pair needs to be broken for the VI to open.) As a result, the petals, which flex during the operation of the VI, can break off from the hub, under out of bound operating conditions. To minimize the likelihood of this happening, contacts 113 and 115 have to be made with enough thickness (—dimension 143), and for heavy duty applications such as in a generator circuit breaker, the contact petals have to be supported one way or another.

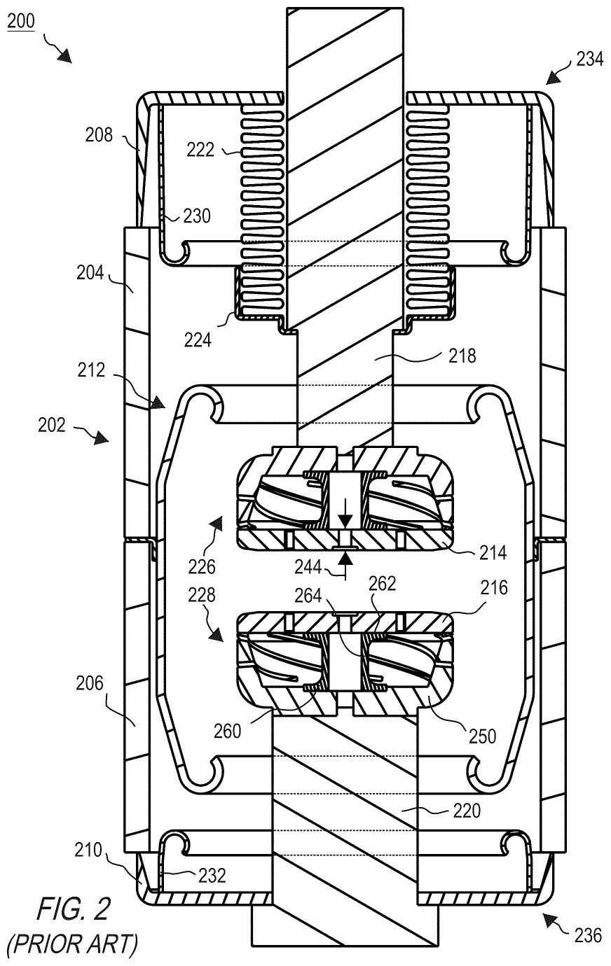

FIG. 2 shows another VI 200 of the other major kind, the AMF type, in accordance with the prior art, which includes a vacuum envelope 202 comprising two tubular ceramic insulator members 204 and 206 caped with two metal end-caps 208 and 210. It also includes a simple shield assembly 212, two electrodes 218 and 220, a bellows 222, and a bellows shield 224, and two end-shields 230 and 232. Unlike VI 100, VI 200 employes a pair of contact-coil assemblies 226 and 228 to generate an axial magnetic field in the opening contact gap, to drive the arc into a diffuse mode for interruption of a high fault current at a high voltage. Commonly in the industry the metal parts are grouped into two ends, a movable end 234 and a fixed end 236, separated by the insulators 204 and 206. The movable end 234 (the upper end in FIG. 2) includes the metal parts 226, 218, 222, 224, 208, and 230. The fixed end 236 (the lower end in FIG. 2) includes the metal parts 228, 220, 210, and 232.

While FIG. 2 shows VI 200 to have identical AMF generating construction of the two contact-coil assemblies 226 and 228 for the movable end and the fixed end respectively, a VI can have different AMF generating constructions between the movable end and the fixed end. For simplicity of description and illustration, only the fixed end AMF generating construction, the contact-coil assembly 228, is described in the following.

As shown in detail in FIG. 2A, the AMF generating contact-coil assembly 228 includes an arc-enduring Cu—Cr or Cu—Fe contact 216, and a generally cup shape coil 250, with six slant “arms” 284, 286, 288, 290, 292, and 294 formed on the side wall of the cup, to channel the current flow into as much as possible a circumferential patten on a plane perpendicular to the axis of the VI tube 200. The top of this AMF generating coil 250 is brazed to the bottom (non-arcing) side of contact 216. To prevent the thin contact 216 from collapsing under compressive loading (such as when the VI is closing), and the coil 250 from deformation under cyclic loading (such as when the VI is being tested to meet the mechanical and electrical endurance requirements), a center mechanical support pillar 260, typically made of a common steel or iron, is placed under the contact 216 and inside the coil 250. Some VIs have this mechanical support 260 not physically joined (brazed) to the bottom side of contact 216. In this case this mechanical support 260 does not offer help when contact 216 is under tensile loading (such as when a weld between the contact pair 214 and 216 has to be broken for the VI to open). Most commercial AMF VIs have this mechanical support 260 brazed to the bottom side of contact 216, for this consideration of tensile loading support. With brazing, the entire faying surface 262 of mechanical support 260 is electrically connected to contact 216. (Electrical connection herein refers to the quantifiable current carrying connection, not the voltage or electrical potential connection.) As a result, a significant fraction of the electrical current from electrode 218 is diverted to flow via mechanical support 260 to contact 216, thereby reducing the current flowing through coil 250, thus weakening the axial magnetic field generated. Because of this concern, the dimensions (in the direction perpendicular to the axis of the VI) of mechanical support 260 have to be limited, leading to a thin central column portion 264. Such a thin column support pillar has, under excessive loading conditions of the VI, the possibility of buckling.

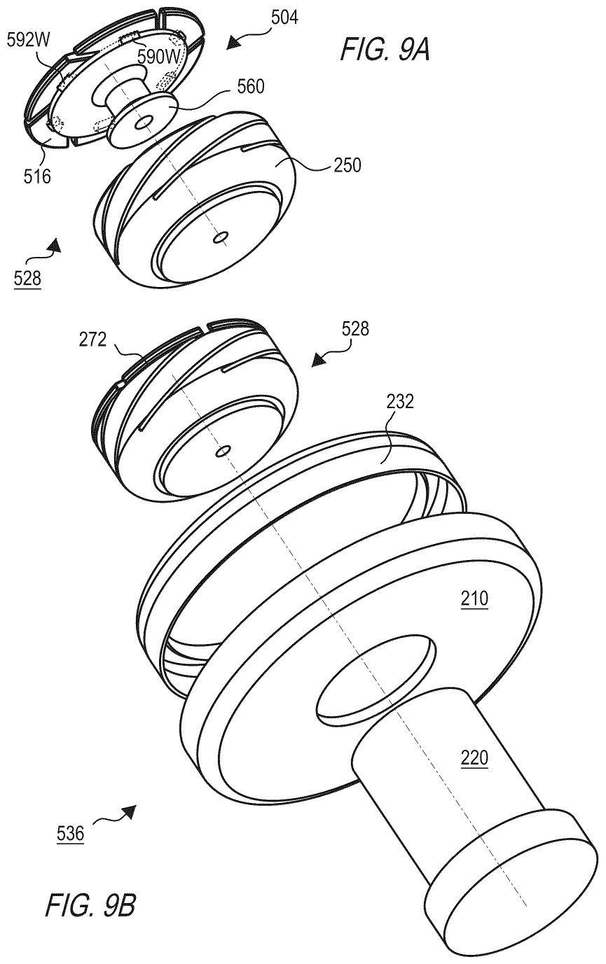

Additionally, because the brazing of mechanical support 260 to contact 216 is carried out in the same furnace brazing run as that for the joining of coil 250 to contact 216, all of the faying surfaces 272 (see also FIG. 9B), 274, 276, 278, 280, and 282 of coil 250 have to be assembled to be co-planar (or parallel if offsetted) with the faying surface 262, and maintained so throughout the furnace heating cycle, to ensure good brazing joint quality. This is not easy as the long slant arms 284-294 of coil 250, which is typically made of an oxygen free high conductivity (OFHC) copper, tend to sag while being heated up in the furnace.

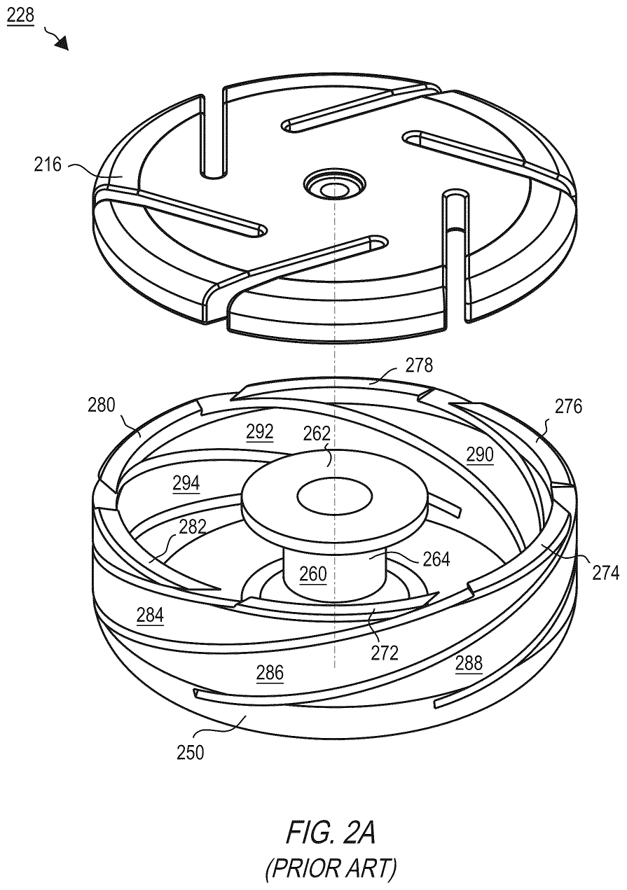

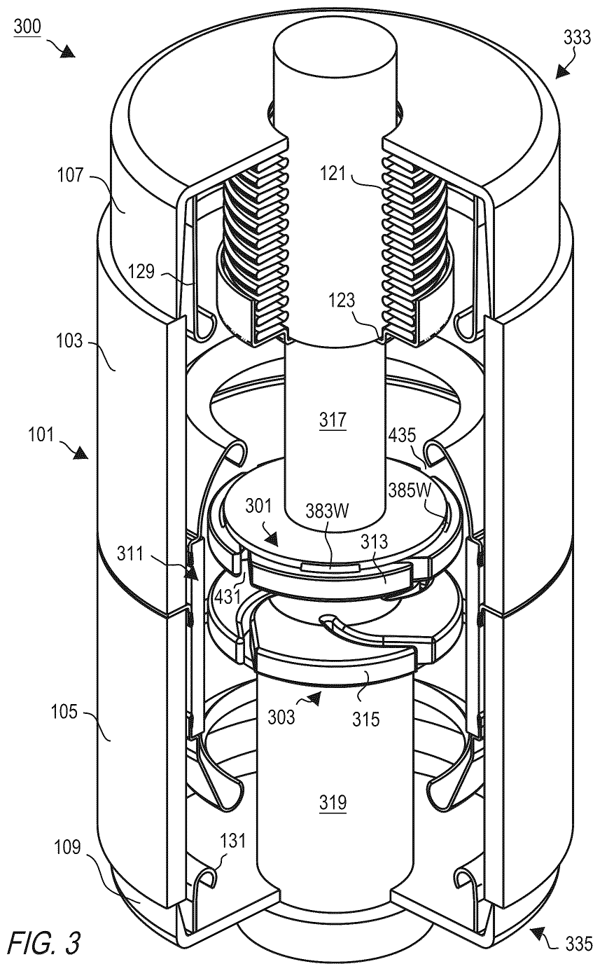

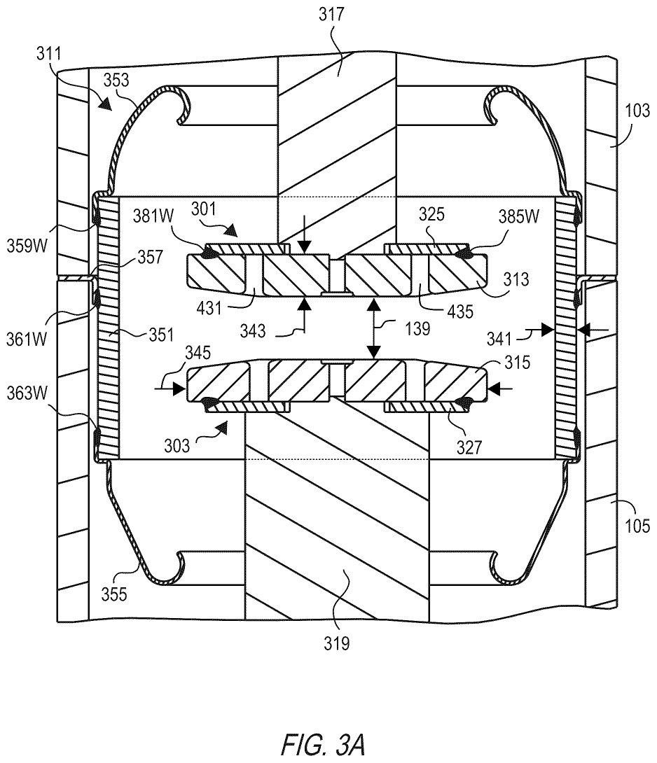

FIG. 3 shows a TMF VI 300 in accordance with certain embodiments of the disclosed concept. Just like VI 100 shown in FIG. 1, VI 300 includes a vacuum envelope 101 comprising two tubular ceramic insulator members 103 and 105 caped with two metal end-caps 107 and 109. It also includes the same bellows 121 and bellows shield 123. Different from VI 100 are the improved shield assembly 311, the thinner contacts 313 and 315, the repositioned and repurposed contact shields 325 and 327, and the slightly modified electrodes 317 and 319 to accommodate the changes in the contacts and the contact shields. The corresponding ends are 333 and 335 respectively.

FIG. 3A gives a sectional view of the improved shield assembly 311. Just like the prior art shield assembly 111 shown in FIG. 1A, shield assembly 311 includes an arc-enduring Cu—Cr or Cu—Fe arc-shield 351, two end-curls 353 and 355 attached to its two ends, and a flange 357. What is important to note is that the joints, 359W, 361W, 363W, between these components are not brazed, but welded instead. By doing so the need to machine the groove 165 and the steps 167, 169, 171 (shown in FIG. 1A) is eliminated. This allows the Cu—Cr or Cu—Fe arc-shield 351 to have a simpler geometry, and a thinner wall (—dimension 341, as compared to 141 in FIG. 1A). Both changes greatly improve its likelihood to be made via net-shape forming. The thinner wall also allows for a larger diameter (—dimension 345, as compared to 145 in FIG. 1A) for contacts 313 and 315, resulting in an improved performance of VI 300. Additionally, because there is no more need to manually assemble the braze filler part into a groove or step, then to braze the assembly through an expensive and time-consuming furnace heating and cooling cycle, the shield assembly manufacturing process is more adapted to automation, for lower cost and shorter lead time.

While it is an option to weld all the joints of shield assembly 351, other options are possible, for example, to only weld the joints 359W and 363W of end-curls 353 and 355 to arc-shield 351, leaving the joint 361W of flange 357 to arc-shield 351 to be brazed in a subsequent brazing furnace cycle together with other components of VI 300. (That joint 361W will be a brazed joint in that case.) Also, while FIG. 3A shows the welding to cover the entirety (i.e. 360 azimuthal degree) of each joint of 359W or 361W or 363W, it is possible for the welding to be only at certain preferred locations of the joint, making use of one advantage welding has over brazing, which will be further exploited in the following contact pre-assembly embodiments.

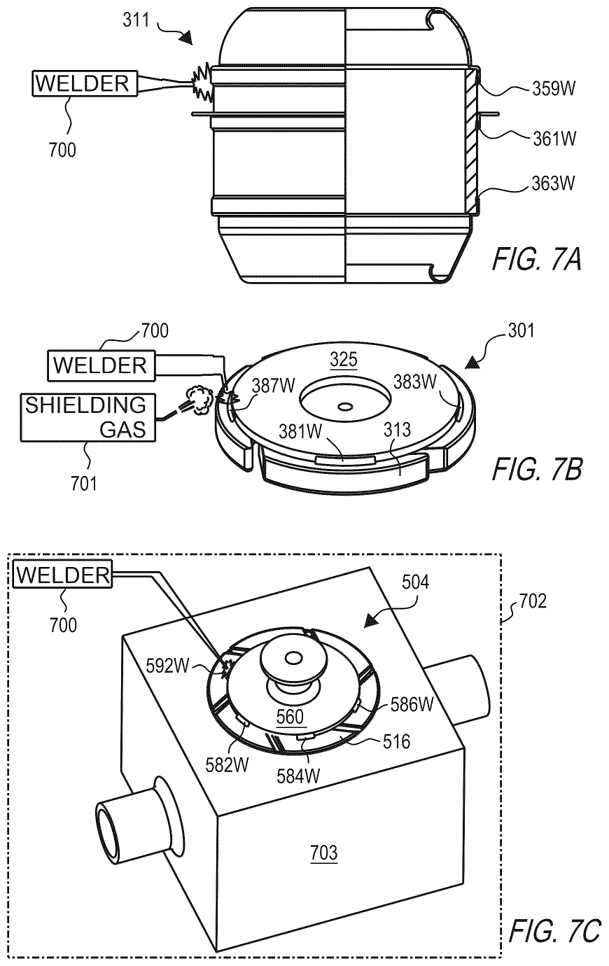

Referring now to contact 313 in FIG. 3A, note that it is thinner than contact 113 of the prior art VI 100 shown in FIG. 1A. This is feasible now because contact 313 is supported at the outer edge by a mechanical support 325. If this mechanical support 325 were to be brazed to contact 313, there would be a very significant diversion of the electric current flow from electrode 317 to contact 313, via mechanical support 325. This would be very undesirable for the high current interruption performance of the VI. By employing welding instead as the joining method and by only selectively welding mechanical support 325 to contact 313 at certain strategic locations, for example 381W, 383W, 385W, and 387W (see also FIG. 7B), mechanical support 325 can provide adequate mechanical support to the contact petals, without significant diversion of electric current, because of its limited direct electrical connection to the contact. As previously stated, for the most demanding applications such as in a generator circuit breaker, such mechanical support to the contact petals is a must. Even when it is not a necessity for other applications, this support to the petals allows contact 313 to be made thinner (—in dimension 343, as compared to 143 in FIG. 1A) thus improving the likelihood of net-shape forming it, at least near-net-shape forming it, with the narrow slots 431-437 (shown also in FIG. 3 and FIG. 4) formed rather than dry milled with a small diameter end-mill toolbit. (A major difficulty of net-shape forming has to do with the density gradient from the exterior to the interior of a pressed green body, and the resulting shrinkage rate variation along the thickness dimension during the subsequent sintering process.) A thinner contact also uses less of the expensive Cu—Cr or Cu—Fe material. A lighter movable contact also places less demand on the power (and cost) of the driving mechanism that moves it.

As shown in FIG. 3, mechanical support 325 also doubles as the contact shield, playing the role of contact shield 125 (in FIG. 1) in catching metal splash and vapor escaping through the slots 431-437 in between the petals (411-417, shown in FIGS. 4 and 8A) of the contact.

While the mechanical support 325 as shown in FIG. 3 is of a simple washer shape for economic considerations, the ability of the welding (as opposed to brazing) to decouple the contradiction between mechanical and electrical performances opens up possibilities in the design of the mechanical support. Just as an example FIG. 4 shows one such mechanical support for another contact pre-assembly 401 in accordance with the disclosed concept, where partial slots (of void), 451, 453, 455, and 457, may be easily punch-press formed into the mechanical support 425, to reduce its undesirable (albeit small) effect of electrically shorting the slots (of void) 431-437 of the TMF contact 313, if any particular application situation of the VI requires so.

The VI in FIG. 3 shows the movable end 333 and the fixed end 335 to have identical construction in the mechanical support 325 or 327 and the contact 313 or 315 (except that the direction of the spiral rotation is opposite between the movable contact and the fixed contact, one being left-hand rotation and the other being right-hand rotation, as clearly known in the field). It will be understood that the two ends can have different constructions of the mechanical support and the contact, as well as the way the joint between them is formed.

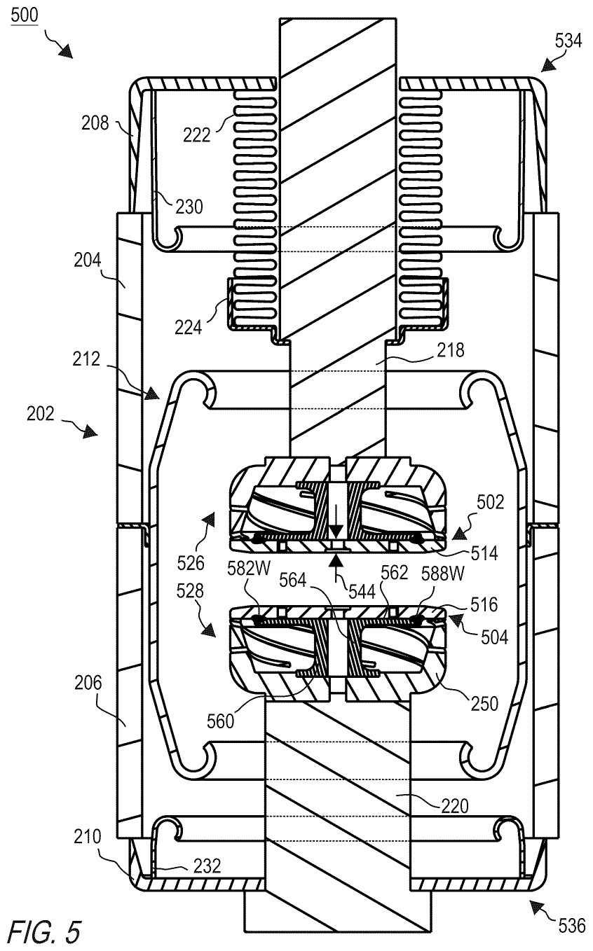

FIG. 5 shows a VI 500 of the AMF type, in accordance with certain embodiments of the disclosed concept. Its differences from the prior art AMF VI 200 are the improved center mechanical support 560, the slightly thinner contact 516, and most importantly, the joint between them. In VI 200, that joint is a brazed joint, and as a result the entire faying surface 262 of the top of 260 is electrically connected directly to contact 216. By employing welding to join mechanical support 560 to contact 516 in VI 500, and only selectively weld predetermined strategic location or locations, for example 582W, 584W, 586W, 588W, 590W, and 592W (see also FIGS. 7C and 9A), the direct electrical connection between mechanical support 560 and contact 516 is very limited. This minimizes the concern for the electrical current being diverted by and through mechanical support 560, from the intended and desired current flow through coil 250. This in turn frees up limits in the design of mechanical support 560, which now has a larger diameter for its top face 562 (than 262) to better support the thin contact, and a beefier center portion 564 (than 264) to support the entire column of the assembly 528. As previously stated, this ability of the mechanical support to achieve minimal current diversion while providing maximal and optimal mechanical support offers a solution to the technical challenge posted by concurrent requirements of adequate mechanical integrity under demanding loading conditions and outstanding electrical performance, on a VI aiming to be used for high voltages above 72.5 kV.

Additionally, with maximal mechanical support, contacts 514 and 516 can be made thinner (—in dimension 544, as compared to 244 shown in FIG. 2) without concern for their mechanical strength not being enough. This saves the use of the expensive Cu—Cr or Cu—Fe material, and lends contacts 514 and 516 more to net-shape or near-net-shape forming.

Moreover, with the mechanical support already welded on the contact, it is much easier (and operationally safer) to chuck on the mechanical support (than to grip on the thin contact itself) to machine a smooth round along the edges of the slots on the contact arcing surface, to ensure a good dielectric performance of the contact.

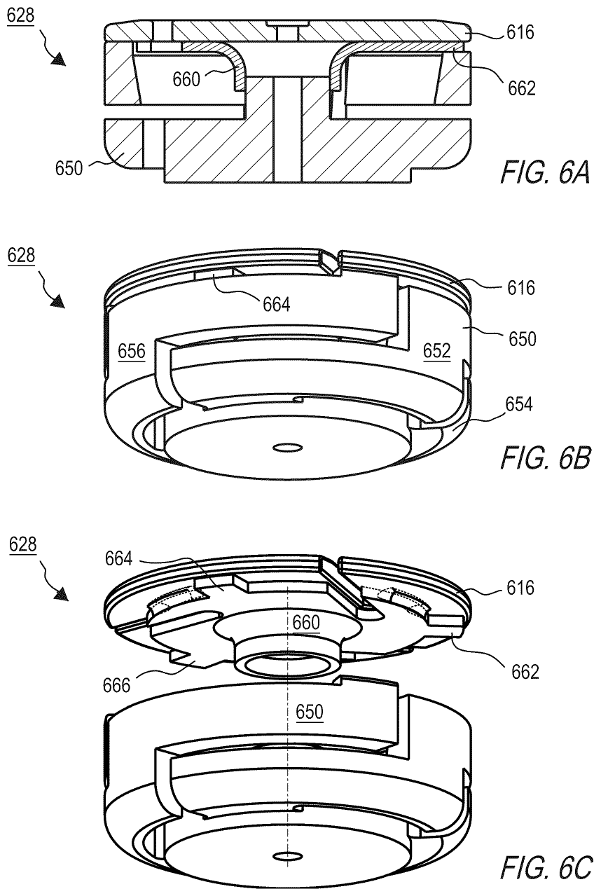

The advantage of welding (as opposed to brazing) being able to delink direct electrical connection from mechanical (abutting) connection also enables great flexibility in the design of the contact-coil assembly, in particular the mechanical support and the coil. Just as an example, FIG. 6 shows another contact-coil assembly 628, in accordance with the disclosed concept. It uses a mechanical support 660 that has additional protrusions 662, 664, and 666 that are strategically wedged in between the bottom of the contact 616 and the top of the coil arms 652, 654, and 656, to reduce the (degree of) flexing of the very long arms and the associated deformation of the AMF generating coil 650. These protrusions 662-664 are not electrically joined to the coil arms at their mutual faying surfaces, so they do not divert (i.e. provide a shorting path to) the current flow along the arms of the coil. Such a mechanical support 660 minimally connected electrically to the contact, working in conjunction with the corresponding modification in the coil 650, may be a punch-pressed part, instead of a machined part, with low cost and yet high mechanical supporting performance.

Although not illustrated herein, there are AMF VIs employing a magnetic flux concentrator inside the coil to manipulate the AMF profile. Such a flux concentrator is made of an iron, such as pure iron or electrical iron or soft magnetic iron. Without concern for current diversion, it can now also be welded to the non-arcing side of the contact, to also serve as a mechanical support to the contact.

Moving on to the welding process, FIG. 7A illustrates the joint 359W between end-curl 353 to arc-shield 351 being welded by a welder 700 (shown in simplified form). For example and without limitation, the welder can be a machine employing laser beam welding or electron beam welding or plasma welding. In FIG. 7B the mechanical support 325 is being welded to contact 313, to form the contact pre-assembly 301. Also shown in FIG. 7B is a means 701 (shown in simplified form) to provide a shielding gas such as argon or helium over the welding spot to reduce discoloration of the workpiece being welded on. In FIG. 7C the mechanical support 560 is being welded to the AMF contact 516. FIG. 7C also shows yet another means to reduce workpiece discoloration by providing a protected environment such as a chamber filled with an inert gas (not shown) or a pumped down chamber 702 (shown in simplified form), in which the welding is carried out. Also shown in FIG. 7C is yet another means to further reduce workpiece discoloration, by employing a water-cooled fixture 703 (shown in simplified form) in good thermal contact with the workpiece, in this example the Cu—Cr or Cu—Fe contact 516, while the welding is being performed. Although not shown, other means to further reduce workpiece discoloration can also be employed, such as using a heat sink to cool the workpiece or applying anti-scale coatings or paste to the workpiece.

While the locations and the number, as well as the shape of the weld affected zone, of the strategic welded spots are given for the exemplary VIs 300 and 500 shown in FIG. 3 and FIG. 5 respectively, they are solely for purposes of illustration, and are not intended to limit the scope of the disclosed concept. The number, locations and shapes of these welded spots will depend on several factors including the specific application for which a VI is designed.

Lastly the assembly method is described. Shown in FIG. 8A is an exploded view of the movable end assembly 333 of VI 300. At first the contact 313 and the mechanical support 325 are welded together to form the contact pre-assembly 301 (employing welding means such as illustrated in FIGS. 7A-C.) This pre-assembly 301 is then assembled with the other components, 317, 121, 123, 107, and 129, together with all necessary braze filler parts (not shown), and loaded into furnace to be brazed into the movable end assembly 333. Similarly, FIG. 8B shows the assembling of the fixed end assembly 335. A contact pre-assembly 303 is first formed by welding contact 315 with mechanical support 327. This pre-assembly 303 is then combined with the other components of 319, 109, and 131 and brazed to form 335. Separately the shield assembly 311 is formed by welding the components 351, 353, 355, and 357 together, as illustrated in FIGS. 7A-C. The assemblies 333 and 335, the ceramics 103 and 105, and the shield assembly 311 are then assembled together (not illustrated) and loaded into furnace to be brazed into VI 300.

Alternatively, the two contact pre-assemblies of 301 and 303, as well as the shield assembly 311, may be assembled together with all the other components of 317, 319, 107, 109, 121, 123, 129, 131, 103, and 105, plus all necessary braze fillers parts and loaded into furnace to be brazed together in a single furnace run, in the so-called one-step brazing manufacturing method, to form VI 300.

FIG. 9A illustrates the assembly process for the contact-coil assembly 528 for AMF VI 500. A contact pre-assembly 504 is first formed by welding contact 516 with mechanical support 560, employing welding means such as illustrated in FIGS. 7A-C. It then is assembled with coil 250 to form the contact-coil assembly 528. This contact-coil assembly 528 may be loaded into furnace to be brazed together in a dedicated furnace run. Alternatively, it may be further assembled with other components of 232, 210, and 220 and brazed in a furnace to form the fixed end assembly 536, as illustrated in FIG. 9B. The movable end 534 is built the same way (not illustrated), starting with a pre-welded contact pre-assembly 502. The two end assemblies of 534 and 536 are then assembled with the ceramics 204 and 206, and the center shield assembly 212, and brazed together to form VI 500. Alternatively, the two contact pre-assemblies 502 and 504 may be assembled with all other components and brazed into VI 500 in a single step brazing method.

It will be understood by those skilled in the art that the brazing steps described herein are only exemplary and for illustration only. Other variations are possible.

For the ease of illustration and economy of disclosure, only the shield assembly 311, the welded contact pre-assemblies 301, 303, 401, 502, and 504, the contact-coil assemblies 528 and 628, are described in detail herein, with respect to the VIs 300 and 500. However, it will be understood that shield assemblies, welded contact pre-assemblies, and contact-coil assemblies in accordance with the disclosed concept could be used in any known or suitable combination or alternative arrangement with any known or suitable alternative vacuum switching apparatus therefor, without departing from the scope of the disclosed concept. For example and without limitation, they could be employed with a VI with a TMF contact structure but without an arc-shield assembly, or a hybrid of the TMF and the AMF operating principles, or a vacuum switching apparatus having two movable ends rather than the aforementioned arrangement of a movable end and a fixed end, or a vacuum switching apparatus having more than two contacts such as a 3-position vacuum switch. Various modifications and alternatives to the specific embodiments could be developed in light of the overall teachings of the disclosed concept which is to be given the full breadth of the claims appended and any and all equivalents thereof.

1. A method for assembling a vacuum interrupter, said vacuum interrupter including a vacuum envelope and at least one of a shield assembly or a contact pre-assembly inside said vacuum envelope, wherein said method comprises:
providing an arc-shield or a contact made of an arc-enduring first material containing at least 40 percent by weight of copper;
providing a second component made of a second material containing no more than 10 percent by weight of copper;
welding at least part of the joint or joints between said arc-shield or said contact and said second component, to form said shield assembly or said contact pre-assembly; and
assembling said shield assembly or said contact pre-assembly with other components of said vacuum interrupter.

2. The method of claim 1, wherein said first material contains at least an element of copper (Cu) and an element of chromium (Cr), or at least an element of copper (Cu) and an element of iron (Fe).

3. The method of claim 1, wherein said first material is an alloy of copper and chromium or an alloy of copper and iron, and said second material is selected from the group consisting of a steel such as but not limited to stainless steel or carbon steel or electrical steel, and an iron such as but not limited to pure iron or soft magnetic iron or electrical iron.

4. The method of claim 1 further comprising forming said arc-shield net-shape, with no subsequent machining required.

5. The method of claim 1 further comprising forming said contact of said contact pre-assembly net-shape, with no subsequent machining required.

6. The method of claim 1, wherein said contact of said contact pre-assembly has at least one slot and said contact of said contact pre-assembly is formed near-net-shape, with said at least one slot formed before any subsequent machining.

7. The method of claim 1, wherein said welding is carried out only at certain strategic location or locations and not the entirety of the mutual faying surfaces of both components being welded together.

8. The method of claim 1, wherein said welding step comprises employing welding means including but not limited to: laser beam welding, or electron beam welding, or plasma welding.

9. The method of claim 1, wherein said welding step further comprises employing means to minimize discoloration of the workpiece being welded on, said means including but not limited to: using a shielding gas such as argon or helium, carrying out the welding in an environmentally controlled chamber such as a pumped down chamber or a chamber filled with an inert gas, or using a water-cooled fixture or a heatsink in close thermal contact with the workpiece, or applying anti-scale coatings or paste to the workpiece.

10. A shield assembly or a contact pre-assembly for a vacuum interrupter, said vacuum interrupter comprising a generally tubular vacuum envelope, at least one electrical contact inside said vacuum envelope, and at least one of said shield assembly or said contact pre-assembly inside said vacuum envelope,
wherein said generally tubular vacuum envelope defines a central axis for said vacuum interrupter;
wherein said shield assembly comprises at least one arc-shield, made of an arc-enduring material containing at least 40 percent by weight of copper, inside said vacuum envelope and surrounding said at least one contact, said at least one arc-shield having one end and an opposite end along said axis of said vacuum interrupter, or
wherein said contact pre-assembly comprises a contact made of an arc-enduring material containing at least 40 percent by weight of copper, said contact having an arcing side on which arcing takes place when said vacuum interrupter is interrupting an electrical current, and a non-arcing side opposite said arcing side along said axis of said vacuum interrupter;
wherein said shield assembly or said contact pre-assembly comprises at least one second component made of a material containing no more than 10 percent by weight of copper; and
wherein said second component is welded to said one end of said at least one arc-shield of said shield assembly, or to said non-arcing side of said contact of said contact pre-assembly.

11. The shield assembly of claim 10, wherein said at least one arc-shield is an alloy of copper-chromium or an alloy of copper-iron, and said at least one second component is made of a steel such as but not limited to stainless steel or carbon steel or of an iron such as but not limited to pure iron or electrical iron.

12. The shield assembly of claim 11, wherein said at least one arc-shield is formed net-shape.

13. The contact pre-assembly of claim 10, wherein said contact of said contact pre-assembly is of the spiral petal transverse magnetic field (TMF) type.

14. The contact pre-assembly of claim 10, wherein said contact of said contact pre-assembly is of the axial magnetic field (AMF) type.

15. The contact pre-assembly of claim 10, wherein said vacuum interrupter further comprises at least one AMF generating coil (250,650), wherein said coil adjoins said contact pre-assembly to form a contact-coil assembly (526,528,628).

16. The contact pre-assembly of claim 10, wherein said contact of said contact pre-assembly is an alloy of copper-chromium or an alloy of copper-iron, and said at least one second component is made of a steel such as but not limited to stainless steel or carbon steel; or of an iron such as but not limited to pure iron or electrical iron.

17. The contact pre-assembly of claim 16, wherein said contact of said contact pre-assembly is formed net-shape or near-net-shape.

18. A vacuum interrupter comprising at least one of the shield assembly or the contact pre-assembly as set forth in claim 10, and an evacuated vacuum envelope.

19. A vacuum switching apparatus comprising the vacuum interrupter as set forth in claim 18, and a driving mechanism operatively connected with said vacuum interrupter.

20. A gas insulated switchgear, or a dead-tank circuit breaker, or a live-tank circuit breaker, or a generator circuit breaker, or a vacuum circuit breaker, or a vacuum recloser, or a vacuum fault interrupter, or a vacuum load break switch, or a vacuum contactor, comprising the vacuum interrupter as set forth in claim 18, and a driving mechanism operatively connected with said vacuum interrupter.
